(19) United States
(12) Patent Application Publication
(10) Pub. No.: US 2014/0149956 A1
(43) Pub. Date: May 29, 2014

(54) CORNER SPECIFIC NORMALIZATION OF STATIC TIMING ANALYSIS

(71) Applicant: INTERNATIONAL BUSINESS MACHINES CORPORATION, Armonk, NY (US)

(72) Inventors: Eric J. Fluhr, Round Rock, TX (US); Stephen G. Shuma, Underhill, VT (US); Debjit Sinha, Wappinger Falls, NY (US); Michael H. Wood, Hopewell Junction, NY (US)

(73) Assignee: International Business Machines Corporation, Armonk, NY (US)

(21) Appl. No.: 13/686,989

(22) Filed: Nov. 28, 2012

(51) Int. Cl. G06F 17/50

(52) U.S. Cl. CPC G06F 17/5045
USPC 716/113

(57) ABSTRACT

A method and a system for expressing results of a timing analysis of an integrated circuit (IC) chip design as relative values to drive efficient chip design closure include: using a computer, performing the timing analysis to compute timing results of the chip design across at least two design corners; applying corner specific normalization equations to the timing analysis results from each of the at least two corners to obtain normalized timing results; and using the timing results ordered and filtered by the normalized timing results of the IC chip design for the design closure prior to chip manufacture. The slacks are normalized to provide insight into the degree of difficulty of the required fixes for that slack across corners. Given multiple analyses, the slacks are fixed in a correct order across corners and paths, avoiding inefficient circuit solutions or cost greater design effort.

### FIELD OF THE INVENTION

The present invention relates to integrated circuit (IC) design and the application of Electronic Design Automation (EDA) based on static timing analysis (STA) tools to circuits, and more particularly, it relates to ordering test points and corners (conditions) when applying an STA across multiple timing analysis design corners for efficient chip design closure.

### BACKGROUND

Conventional circuit Static Timing Analysis (STA) is used to validate and compute signal propagation and arrival times at multiple points in a given circuit. A path in a circuit denotes a topologically ordered set of connected circuit components that allow electrical signal propagation. STA computes the signal arrival times along points in a path, and thus can be used to compute signal propagation times or delays of any path. FIG. 1 illustrates a block diagram depicting two paths in a circuit that have a timing constraint between their respective end (or sink) test points. Path 1 starts at input 101, propagates through elements 102-108, and ends inside circuit element 110. Path 2 also starts at the same input 101, but propagates through element 109, ending at a different point within element 110. A timing constraint (commonly referred to as timing test) is assumed between the end points of the paths within common element 110 represented by a Flip/Flop (F/F). The test implies that a minimum signal arrival time difference (referred to as timing margin) is required between the two end points of the test. STA calculates the propagation delay of a signal through each of these paths by summing the delay of the individual circuit elements in that path and generates a passing or failing answer for the timing test based on the computed arrival times and margin. The magnitude of the answer is called the timing slack, which can be represented by a mathematical formula of the form:

Slack=(Signal arrival time of path 2)−(Signal arrival time of path 1)−(Test margin).

A typical IC design contains multiple such circuit paths and associated test points.

Referring to FIG. 2, a block diagram is illustrated showing a design having multiple paths identified as Path A, Path B, Path C and Path P, and corresponding test points.

Historically, timing analysis of a circuit during IC design has been performed at a single design corner. A design corner represents a condition or state of multiple physical parameters which impact circuit timing. Common examples of parameters include environmental parameters like voltage and temperature, and manufacturing process parameters like transistor channel length, dopant concentration, interconnect metal thickness, and the like. At a given corner, each parameter is assumed to be at a known state (for example, voltage at 1.1 volts, temperature at 85° Celsius, and channel length at 45 nanometers). A timing analysis at a design corner validates the circuit functionality at that corner, but cannot predict circuit behavior if any of the parameters changes (at a different corner). Given that circuits are expected to work across a range of environmental parameter conditions, as well as through uncertainty of manufacturing process parameter corners, a multiple corner STA is essential. A Statistical Static Timing Analysis (SSTA) extends single-corner STA by applying statistical timing models to the circuit elements and associated slacks of tests. Statistical models denote expected variations in parameters via probabilistic distributions, and thus capture the circuit timing behavior (including slacks) as statistical quantities with known distributions instead of fixed numbers. The distribution of any statistical slack represents numeric slack values across the range of parametric variations. Consequently, for each test of a circuit, the SSTA tool can provide slack results across multiple corners, and can additionally predict which corner yields the numerically worst slack.

A common method of representing the result of timing analysis on an IC design is to list tests and corresponding slacks in a sorted order (from worst to best). In single corner STA, each unique test is listed only once, representing the slack for that test at the given corner. In SSTA or multi-corner STA, each unique test may be listed either once for every corner, or may be listed only once while indicating the worst slack across all corners along with the corner which yields that value. The latter approach is a common simplification for human use. Additionally, such a “single-valued” result is often required by IC design closure tools that query timing analysis for validation of circuit construction.

Different circuit elements exhibit different performance characteristics with respect to different parameters. For example, the delay response of transistors or logic gates to voltage variation is more significant than the delay response of circuit interconnects or wires to voltage variation. Test slacks are thus strongly dependent on the physical characteristics of the circuit elements in the paths leading to the tests. While a path delay (and thereby the corresponding slack of the test that the path may feed) dominated by transistors will be highly sensitive to the voltage parameter, the delay of a path dominated by wires will observe negligible delay (or slack) differences across different voltage corners. While two paths leading to a test can have similar delays at a given corner, the delays may be widely disparate at another corner if the two paths are constituted of disparate circuit elements.

Similar circuit elements contained in both paths lead to path delays and their differences can be correlated. For example, to a first order, the delay of logic gates (e.g. INVERTER, NAND, etc.) in both paths will change in magnitude and direction (i.e. larger or smaller) similarly with respect to voltage. A path containing ten such logic gates of 10 picoseconds (ps) each at a high voltage corner will have a propagated delay of 10×10 ps=100 ps. If the logic gate delay at a lower voltage is 30 ps, the delay is calculated as 10×30 ps=300 ps. The correlated path delay ratio in this example across the two voltage corners is thus 300%. This correlated difference can prevent the magnitude of slacks at different design corners from being directly compared, even when the required effort to meet a slack target is identical. When listing the test point slacks in numerical order by worst magnitude, the corner with the largest values appear earlier in the list or become the first reported corner. This behavior can be acceptable if the design effort remains consistent across design corners, as any effort to fix the slowest corner will equally fix all other corners. However, this behavior is sub-optimal if the design effort to fix the tested slack for a given point differs amongst the various corners and is worse for the corner with lowest magnitude slacks.

Variations in the effort required to fix slacks between corners can be introduced by uncorrelated differences in the paths based on differences in the path topologies. Still referring to FIG. 2, if path A constitutes of 30% transistors and 70% wires, while path B constitutes of 70% transistors and 30% wires, the delay of paths A versus B will differ even though the delay of the each constituent IC element is identical across different corners. Given paths A and B having ten elements consisting of a mixture of transistors and wires, where each wire delay is 5 ps and is not affected by voltage, and each transistor delay is 10 ps at the voltage corner High and 30 ps at the voltage corner Low, the two paths behave as follows:

Voltage High, path A=3×10 ps+7×5 ps=65 ps,

Voltage Low, path A=3×30 ps+7×5 ps=125 ps,

Voltage High, path B=7×10 ps+30×5 ps=85 ps, and

Voltage Low, path B=7×30 ps+3×5 ps=225 ps.

The change in propagated delay of path A is (125−65)/65=92.3% while the change in propagated delay of path B is (225−85)/85=164.7%. The difference in propagated delay ratio demonstrates the variation that occurs for delays (and thereby slacks) across corners for different path topologies.

When combined with the correlated difference, the uncorrelated difference in delay between two tested paths can reorder the worst effort paths across the corner. For instance, the timing slacks obtained from performing SSTA on the design in FIG. 2 is reported for each path, for both voltage corners, in table 301 of FIG. 3. Table 302 in FIG. 3 depicts a timing report from the SSTA tool wherein the most critical corner (corresponding to the worst slack) is reported with the corner information across paths in a sorted fashion (ordered from most negative slack to least negative slack). Given that the device delays are larger at the Low corner (lower voltage leads to smaller circuit currents that result in slower signal transitions, thereby causing larger device switching delays), the slacks are commensurately more negative. As a result, the worst slacks in the ordered timing list are all from the Low voltage design corner in the convention SSTA analysis flow. It is observed that the worst three paths [A, B, C] ordered in the Low voltage corner may become [A, C, B] in the High voltage corner. The reordering of paths prevents the associated slack values across corners from providing insight into the degree of difficulty of the required timing fixes in each corner. A fix in one specific corner may solve fails in all other corners, while a fix in another corner may only solve the timing problems for that corner, or perhaps a subset of the other corners tested. Given multiple corner analyses and slacks that vary by path across corners, fixing path slacks in the wrong order may drive inefficient circuit solutions or cost greater design effort than is necessary. It is therefore important to address the problem of determining the path and corner that should be fixed first.

Prior and current approaches to multiple corner analysis fall into two categories: designer-directed and design-automation directed. Designers rely on multiple timing reports, solving the timing problems by iterating through each report in a serial fashion. Alternately, designers post-process the reports to identify common paths and apply manual multi-corner analysis to identify the most efficient fix. Design-automation tools take a brute-force approach, fixing fails directly as reported by the timing analysis tool, beginning with the worst absolute magnitude fail. If the worst magnitude fail does not fix a specific fail in all corners, the optimization algorithm will continue to iterate on fixes for that fail in the next worst magnitude corner. Given that these approaches do not know a priory the mathematical relationship of the timing analysis results between different corners, both designer and design-automation techniques must check and solve all possible timing solutions. Checking all the solutions can require increased iterations to solve all of the design timing problems than an optimal analysis indicates is obtainable. To minimize the effort of iteration, the process needs a method to compare and order slacks across corners to guide the design effort in an efficient way.

### BRIEF DESCRIPTION OF THE DRAWINGS

The accompanying drawings, which are incorporated in and which constitute part of the specification, illustrate the presently preferred embodiments of the invention which, together with the general description given above and the detailed description of the preferred embodiments given below serve to explain the principles of the invention.

FIG. 1 is a block diagram depicting paths of a prior art circuit having a timing constraint between their respective end test points.

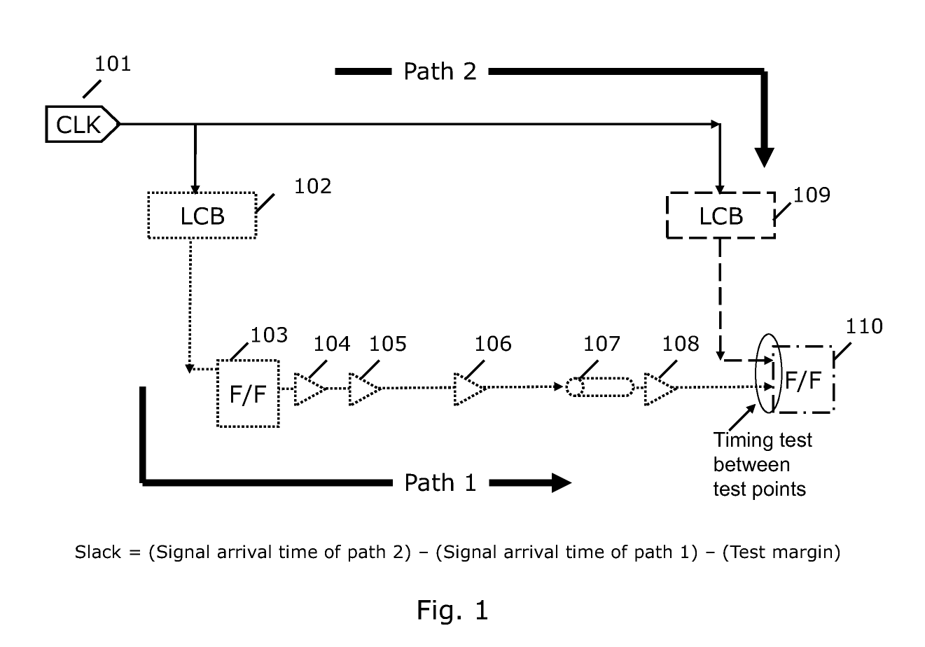

FIG. 2 is a block diagram showing a prior art design with multiple paths and corresponding test points.

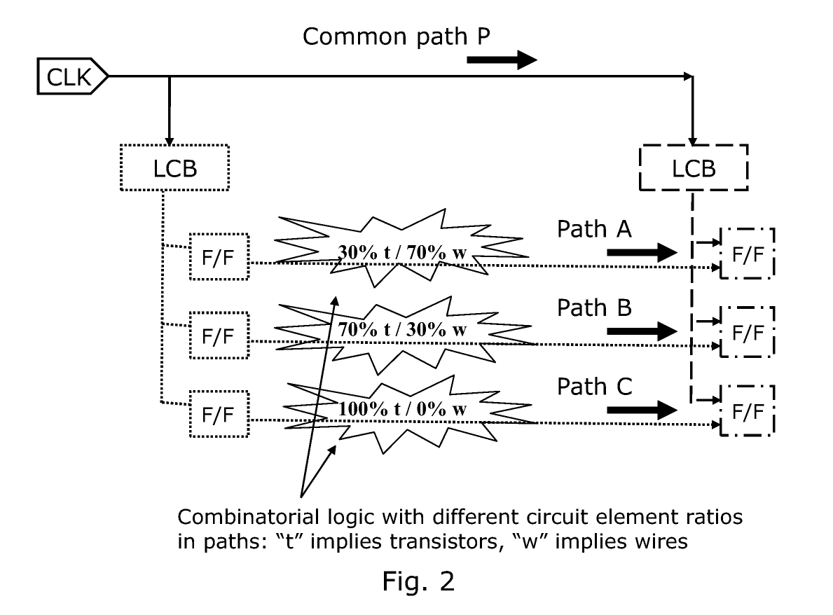

FIG. 3 shows a set of tables illustrating the results of prior art SSTA in the absence of any corner based normalization, wherein the most critical corner (corresponding to the worst slack) is reported with the corner information across paths in a sorted fashion.

FIG. 4 illustrates a flow chart showing a normalization of the static timing analysis, according to an embodiment of the invention.

FIG. 5 shows tables illustrating the results of SSTA after corner based normalization, wherein one entry per path is produced, indicating the worst effort corner according to the most negative relative condition slack.

### BRIEF SUMMARY

Accordingly, in an embodiment of the present invention, a method and a system are provided to perform a timing analysis of the circuit design across multiple design corners when applying normalization to compare and order the result of the analysis across the design corners.

In another aspect, an embodiment normalizes the slacks, providing an insight into the degree of difficulty of required fixes for the slack across corners. Given multiple analyses, in one embodiment, the method achieves fixing slacks in a correct order (across corners and paths), and avoids inefficient circuit solutions or cost greater design effort than necessary.

In a further aspect, one embodiment compares and orders the slacks based on some priority by using an equation that normalizes the slacks to a common relative condition.

In yet another aspect, a method is described for expressing results of a timing analysis of an integrated circuit (IC) chip design as relative values to drive efficient chip design closure, the method including: using a computer, performing the timing analysis to compute timing results of the chip design across at least two design corners; applying corner specific normalization equations to the timing analysis results from each of the at least two corners to obtain normalized timing results; and using the timing results ordered and filtered by the normalized timing results of the IC chip design for the design closure prior to chip manufacture.

### DETAILED DESCRIPTION

The present invention and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the present invention in detail.

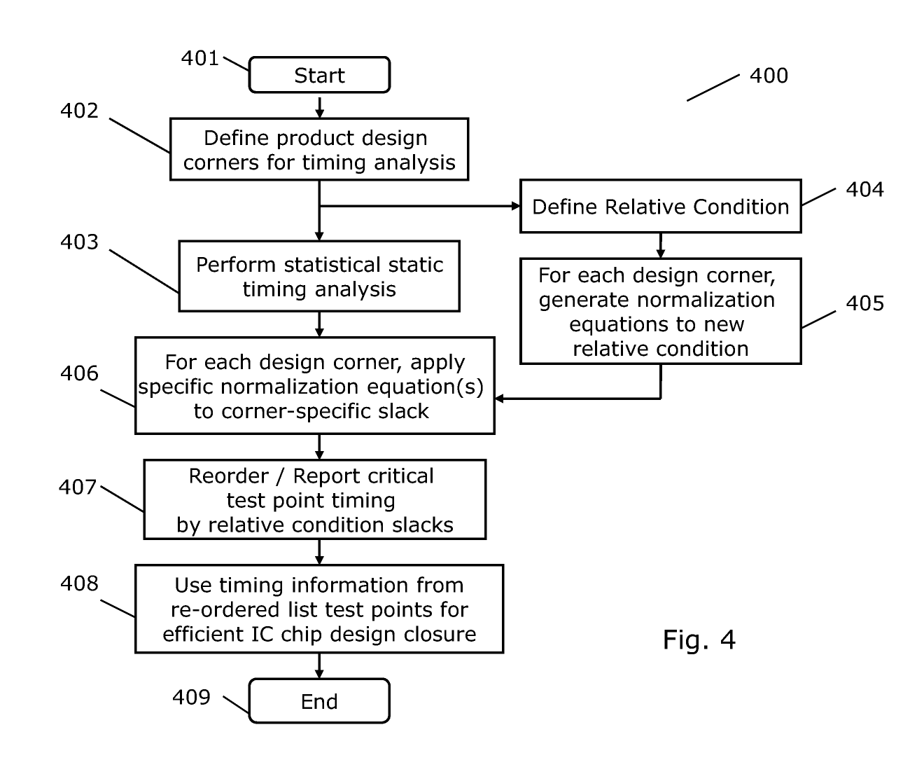

Referring to FIG. 4, a flow diagram illustrates an embodiment of method labeled 400 for timing analysis of a given circuit/chip design with alternate normalization.

The method 400 is initialized in step 401. The design, timing models, and timing assertions are read. In step 402, design corners are defined. Typically, timing analysis results (including slacks) will be validated at these corners. In an embodiment, two design corners, termed Low and High are selected, representing two different voltage conditions. Across the two voltage conditions, the circuit device delays are substantially larger at the Low voltage corner than at the High voltage corner. Using circuit simulation to quantify the delay of the circuit elements at the design corners, one can define a parameter (voltage), and the mathematical relationship of propagation delay to the parameter. While one embodiment describes using an example of two design corners, any plurality of design corners and parameters may be defined without any limitations.

Referring to step 403, the specification of the parameter and associated corners enables a statistical static timing analysis on the circuit. During SSTA, timing quantities like delays and signal arrival times are represented as random variables with known distributions and are propagated throughout a timing graph model of the circuit. Required arrival times are propagated in a traditional manner and slacks are obtained at different points in the timing graph. Step 403 may include traditional static timing analysis components like coupling analysis and common path pessimism reduction. Other multi-corner STA approaches may be performed instead of the SSTA.

Once the design corners are defined in step 402, a new “relative condition” or reference corner is selected in step 404. The intent is to normalize any timing quantity (e.g. slack) from any corner to the reference corner. The aforementioned normalization provides a basis for meaningful comparison of slacks across paths and corners to potentially order them in a true critical order of which path and corner are to be fixed first.

In step 405, “normalization equations” that relate each design corner to the relative condition are generated. In one embodiment, a relative condition is chosen as the nominal voltage corner, and the normalization equation for every corner is a unique scale factor. In an embodiment, the scale factor is a unique “FO4” (Fan-Out of 4) ratio. FO4 is an industry standard metric representing the delay of an IC inverter driving a load equivalent to four times the base device size. Given a design corner, a technology (e.g., 32 nanometer IC manufacturing technology) with a smaller FO4 indicates that devices of that technology will perform faster than those from a technology having a larger FO4 (e.g. 65 nanometer IC manufacturing technology). The FO4 ratio for any corner is the ratio of the circuit FO4 delay at that timing corner to the circuit FO4 delay at the relative corner. For typical logic gates, signal propagation delays are larger at lower voltages. Consequently, the FO4 delay is larger at Low voltage than at High voltage. When the FO4 delay is used as the normalization equation, a slack at Low voltage would be scaled down by a larger FO4 value than a slack at High voltage.

Other relationships can determine different normalization equations. Examples include the change of wire delay due to temperature, changes in IC element delay with respect to power consumption, or change in IC delay based on the manufacturing cost of different devices used in the IC design. Multiple normalization equations may be used at the same time. Steps 404 and 405 are independent of the statistical timing analysis step 403 and may be performed up-front once per technology.

In step 406, the normalization equation(s) for each corner is (are) applied to the slacks of that corner. As an example, a test is considered with slacks at Low and High corners being −12 ps and −5 ps, respectively, and the FO4 delays at these corners are assumed to be 6 ps and 1.6 ps, respectively. It is further assumed that the FO4 delay at the defined relative corner in step 404 is 2 ps. The Low and High FO4 ratios are as follows: 3 (=6/2) and 0.8 (=1.6/2), respectively. Scaling the original slacks down with these ratios, the new relative slacks for the Low and High corners are respectively determined to be: −4 ps (=−12/3) and −6 ps (−5/0.8). It is observed that with normalization, the High corner slack is now worse that the Low corner slack.

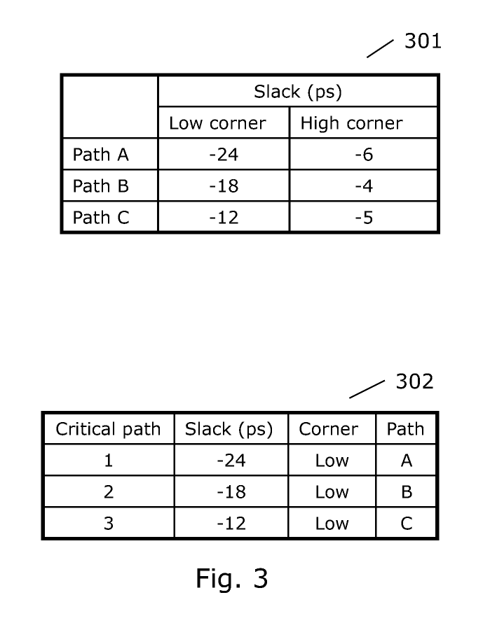

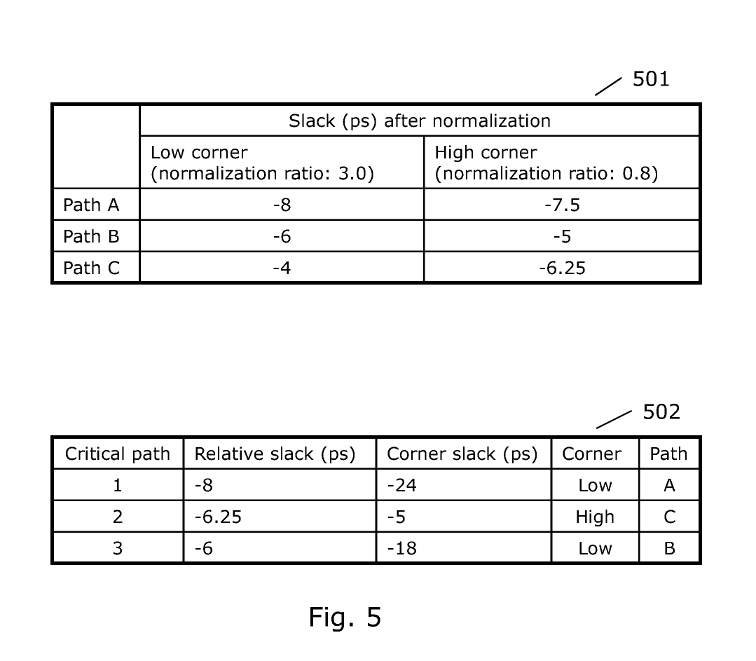

Table 501 in FIG. 5 illustrates results of an embodiment wherein the normalization equation is defined as a FO4 ratio of 3.0 for the Low corner versus the relative condition, and 0.8 for the High corner versus the relative condition. Referring to FIGS. 3 and 5, dividing each test slack of Table 301 by its corner specific normalization ratio yields new normalized timing illustrate results listed in Table 501 of FIG. 5. Comparing the slacks for path C between tables 301 and 501, it is observed that the worst corner now shifts from Low to High, indicating that the High corner requires more effort to fix than the Low corner. Step 407 reports the set of timing paths ordered by the slacks normalized to the relative condition (from worst to best), instead of ordering the set of paths based on the original non-normalized magnitude of slacks. In step 408, chip design closure is guided by post normalization ordering of paths. As part of design closure, either a timing optimization tool or a designer iteratively chooses tests or paths from the reordered set and fixes or validates corresponding timing, which may involve incremental design updates like buffer insertion, gate resizing and wire rerouting.

Referring to Table 502 in FIG. 5, the results of an embodiment are illustrated, wherein one entry per path is produced, identifying the worst effort corner according to the most negative relative condition slack. Comparing the list to prior art Table 302 in FIG. 3, it is observed that the order of critical paths changes from [A, B, C] to [A, C, B], indicating that path C is in reality more difficult to fix than path B. Furthermore, for path C, the worst corner has also changed from Low to High, indicating that fixes should be made with respect to the High corner constraints before the Low corner in order to optimize the iterations needed to meet the slack target. If the Low corner of path C was fixed before the High corner, the High corner slack problem would still remain negative forcing a minimum iteration count of 2.

Using the newly ordered timing according to the relative condition slacks, human or optimization algorithms will work on the slack fails in a new and more efficient order, as defined by the relative condition, instead of worst magnitude order as defined by the initial corner timing. Reporting only a single corner per path simplifies the tool output listings, making them more intuitive for human analysis. The present reporting works particularly well with existing design automation tools that optimize one corner at a time. As the optimization program improves the worst corner and recalculates timing, the reported corner may adjust to the next most difficult corner. By always providing the corner most difficult to fix, embodiments of the invention offer the best possible guidance for prioritizing and/or ordering fixes with high probability of closing all corner fails for a given path.

Considering the aforementioned example of the Low and High corner slacks of a test being originally −12 ps and −5 ps, and −4 ps and −6.5 ps, respectively a post normalization and a buffer insertion as part of the design closure are employed to fix the negative slack problem. In a prior art method on the other hand, the Low corner having\ a slack of −12 ps is considered to be a more critical condition, and a buffer is inserted with delay of +12 ps at the Low voltage condition to compensate for the negative slack. While this may fix the slack at the Low corner (new slack at Low corner now being 0 ps), given FO4 ratios of Low and High corners as 3 and 0.8, respectively, implies that the inserted buffer has a delay of 3.2 ps (=12×0.8/3) at the High corner. The new slack at the High corner thus is reduced from −5 ps to −1.8 ps (=−5+3.2), but still remains negative. Consequently, the design closure requires re-fixing the same test at the High corner by either adding another buffer or by buffer resizing. When the method 400 in FIG. 4 is employed, normalized slacks for the test can be obtained, and the High corner with a normalized slack of −6.25 ps can be observed as the true critical corner. Applying a buffer insertion as part of the design closure fixes the problem, wherein a buffer having a normalized delay of +6.25 ps is added. Given the aforementioned FO4 values, the buffer delays at Low and High corners are as follows: 18.75 ps (=6.25×3) and 5 ps (=6.25×0.8), respectively. The new slack values post buffer insertion are consequently +6.75 ps=(−12+18.75) and 0 ps (−5+5), respectively, both of which are non-negative. The aforementioned example illustrates how the design closure identifies the true worst slack corner and enables the design closure to efficiently fix the problem while employing a lesser number of iterations.

It should be noted that although not explicitly specified, one or more steps of the methods described herein can include a storing, displaying and/or outputting step as required for a particular application. In other words, any data, records, fields, and/or intermediate results discussed in the methods can be stored, displayed, and/or outputted to another device as required for a particular application. While the foregoing is directed to embodiments of the present invention, other and further embodiments of the invention can be devised without departing from the basic scope thereof. Various embodiments presented herein, or portions thereof, can be combined to create further embodiments.

1. A method for expressing results of a timing analysis of an integrated circuit (IC) chip design as relative values to drive an efficient chip design closure, the method comprising:
a) using a computer, performing said timing analysis to compute timing results of said chip design across at least two design corners;
b) applying normalization equations to said timing analysis results from each of said at least two corners to obtain normalized timing results, wherein a relative design corner serves as a reference corner to obtain said normalization equations, and wherein said normalization equations are design corner specific but independent of circuit timing; and
c) using said timing results ordered and filtered by said normalized timing results of said IC chip design for said design closure.

2. The method as recited in claim 1, wherein in step a), said performing said timing analysis is a statistical timing analysis.

3. The method as recited in claim 1, wherein in step a), said performing said timing analysis is a deterministic multi-corner timing analysis.

4. The method as recited in claim 1, wherein in step b) said relative corner is not one of said at least two design corners.

5. The method as recited in claim 1, wherein in step b), said normalization equations are corner specific scale factors.

6. The method as recited in claim 5, wherein said corner specific scale factors are Fan-Out of 4 (FO4) ratios.

7. The method as recited in claim 1, wherein in step b), said normalization is performed on timing slacks.

8. The method as recited in claim 1, wherein in step c), said timing normalized results are used to guide a choice of a worst corner for any path to fix during chip design closure.

9. The method as recited in claim 1, wherein in step c), said timing normalized results are used to guide the choice of a worst path for any of said corner to fix during chip design closure.

10. The method as recited in claim 1, wherein in step a) results of said timing analysis comprise timing quantities consisting of delays, slews, waveforms, test guard-times, timing assertions, and sensitivities.

11. The method as recited in claim 1, wherein in step b), a plurality of normalization equations are applied on said timing normalized results to achieve multiple normalized timing results.

12. The method as recited in claim 11, wherein each design closure step uses at least one of the said multiple results.

13. A system for expressing results of a timing analysis of an integrated circuit (IC) chip design as relative values to drive an efficient chip design closure, comprising:
a) using a computer, performing said timing analysis to compute timing results of said chip design across at least two design corners;
b) applying corner specific normalization equations to said timing analysis results from each of said at least two corners to obtain normalized timing results, and further comprising a relative corner that is not one of said least two design corners serving as a reference corner to obtain said normalization equations; and
c) using said timing results ordered and filtered by said normalized timing results of said IC chip design for said design closure prior to chip manufacture.

14. A non-transitory program storage device readable by a machine, tangibly embodying a program of instructions executable by the machine to perform a method for expressing the results of timing analysis of an integrated circuit (IC) chip design as relative values to drive efficient chip design closure, comprising:
a) using a computer, performing said timing analysis to compute timing results of said chip design across at least two design corners;
b) applying corner specific normalization equations to said timing analysis results from each of said at least two corners to obtain normalized timing results, and further comprising a relative corner that is not one of said least two design corners serving as a reference corner to obtain said normalization equations; and
c) using said timing results ordered and filtered by said normalized timing results of said IC chip design for said design closure.

15. The method as recited in claim 1 further comprising applying corner specific normalization equations that enable better ordering and filtering of timing analysis results to achieve a predetermined efficient design closure of said IC chip.

16. The method as recited in claim 15, wherein said corner specific normalization equations include scale factors and are applied to obtain normalized timing results that enable an improved comparison of timing analysis results across said corners.

17. The method as recited in claim 15, wherein said ordered and filtered normalized timing analysis driving efficient design closure achieve a timing optimization prior to chip manufacturing.
